(19) United States
(12) Patent Application Publication
(10) Pub. No.: US 2017/0011606 A1
(43) Pub. Date: Jan. 12, 2017

(54) Systems, Devices, and/or Methods for Managing Transactions

(71) Applicants: Stefano Ceccon, London (GB); Maciej Trybilo, London (GB)

(72) Inventors: Stefano Ceccon, London (GB); Maciej Trybilo, London (GB)

(21) Appl. No.: 15/204,048

(22) Filed: Jul. 7, 2016

Related U.S. Application Data
(60) Provisional application No. 62/189,266, filed on Jul. 7, 2015.

(51) Int. Cl. G08B 13/24; G06Q 20/20; G06Q 20/18

(52) U.S. Cl. CPC G08B 13/246; G06Q 20/18; G06Q 20/208

(57) ABSTRACT

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to, receiving a universally unique item identifier of an item from a tag reader.

### Cross-References to Related Applications

This application claims priority to, and incorporates by reference herein in its entirety, pending U.S. Provisional Patent Application 62/189266, filed 7 Jul. 2015.

### BRIEF DESCRIPTION OF THE DRAWINGS

A wide variety of potential, feasible, and/or useful embodiments will be more readily understood through the herein-provided, non-limiting, non-exhaustive description of certain exemplary embodiments, with reference to the accompanying exemplary drawings in which:

FIG. 1 is an illustration of an exemplary embodiment of a database;

FIG. 2 is an illustration of an exemplary embodiment of a database;

FIG. 3 is an illustration of an exemplary embodiment of a database relationship;

FIG. 4 is an illustration of an exemplary embodiment of a system;

FIG. 5 is an illustration of an exemplary embodiment of an information device;

FIG. 6 is an illustration of an exemplary embodiment of a tag and multiple UUID's;

FIG. 7 is an illustration of an exemplary embodiment of an information device display showing a tag and multiple UUID's;

FIG. 8 is an illustration of an exemplary embodiment of a UUID being retrieved from a tag;

FIG. 9 is an illustration of an exemplary embodiment of an information device display showing product information;

FIG. 10 is an illustration of an exemplary embodiment of a shopping basket;

FIG. 11 is an illustration of an exemplary embodiment of a security gate device;

FIG. 12 is an illustration of an exemplary embodiment of a relationship between a backend and a security gate device;

FIG. 13 is a flowchart of an exemplary embodiment of a method; and

FIG. 14 is a block diagram of an exemplary embodiment of a system;

FIG. 15 is a flowchart of an exemplary embodiment of a method; and

FIG. 16 is a block diagram of an exemplary embodiment of an information device.

### DESCRIPTION

Certain exemplary embodiments can provide a scalable self-checkout system utilising mobile devices as well as radio tags and tag readers. Via certain exemplary embodiments a self-checkout system can allow for scanning and/or recognising one or more tags associated with a specific item (e.g., a specific can of soup among a group of apparently identical cans of soup on a shelf of a grocery store) and/or for paying for the item. Each tag can be attached to the item and/or can be associated with a set of universally unique identifiers (UUID's) prior to being displayed in a store. The association can allow each item to be uniquely identified by the system. A mobile device with tag reading capability can be used to scan and/or recognise tags and/or to pay for items. Tag detection devices, such as in the form of security gates that can be placed at the exits of the store, can raise an alarm if an item leaving the store has not been paid for.

Certain exemplary embodiments can relate to self-checkout shopping, for example, in clothing stores and/or to methods of mobile self-checkout shopping for items associated with tags, such as Radio-frequency identification (RFID) tags, iBeacons, and/or barcodes (e.g., at least one Quick Response (QR) Code, Linear barcode, Aztec Code, and/or Data Matrix, etc.). RFID tags can be Ultra High Frequency (UHF) and/or RFID Near Field Communication (NFC) tags. A tag can be associated with an item by physically securing the tag to the item using, for example, a sticker and/or a lace.

Certain exemplary embodiments can provide and/or utilize at least one RFID UHF reader, which is a device that can detect and/or read RFID UHF tags. Such readers can be implemented in the form of gates where tags passing through the gates are read, potentially leading to actuation of an alarm if the tag is determined to not be associated with a purchase.

Certain exemplary embodiments can provide a website and/or mobile application for:
(i) enabling a customer to scan a tag associated with an item;
(ii) recognising the item;
(iii) causing information about the item associated with the scanned tag to be displayed to the customer; and/or
(iv) allowing the customer to pay for the recognised item.

Certain exemplary embodiments can provide a system for identifying and/or tracking the payment status of each item individually and/or maintaining an association with corresponding general product data. For this purpose, every unique item (e.g., a specific can of soup (an “item”) among a group (a “product”) of apparently identical cans of soup on a shelf of a grocery store) can be assigned and/or associated with one or more of universally unique item identifiers prior to being displayed in a store. Physically this association can be achieved by attaching to the item one or more identifier tags that encode and/or store the unique identifier(s). The identifier tag(s) can take any of different forms of tag technology, such as RFID tags (UHF or NFC), proximity beacons (e.g., Bluetooth low energy proximity beacons, such as Apple's iBeacon®), and/or barcodes (e.g., QR Code, Linear barcode, Aztec Code, and/or Data Matrix, etc.). The system can maintain the knowledge of such associations thanks to computational database storage, communication networks, software, and/or sensors for detecting and reading the tag(s), e.g., an NFC reader on a mobile device, RFID-enabled security gate, RFID detection device, and/or an imaging device coupled with barcode recognition software. Thus, each universally unique physical item has one or more UUID's that are each encoded/stored in one or more tags, each of those tags utilizing a distinct tag technology. For example, a first UUID can be encoded and/or stored in an RFID tag, a second UUID can be encoded and/or stored in an proximity beacon, and/or a third UUID can be encoded and/or stored in a barcode tag, etc. In this example, for the specific item, each of its UUID's can be unique with respect to each other, or can be the same. Moreover, each of the UUID's for the specific item can be unique within its particular tag technology with respect to all other items, including items that to the human senses appear to be physically identical to the specific item (i.e., all items of a given product).

Because the items can be recognised at different stages of the checkout process by devices with different sensor capabilities, the items can be fitted with one or more tags, and/or one or more different kinds of tags. For instance, an NFC tag can be supplied to allow reading by NFC-enabled mobile devices, a barcode can be supplied to allow reading by camera-enabled mobile devices, and/or a UHF tag can be supplied to allow tracking and/or detecting the items at a larger distance by the RFID-enabled security gates and/or other RFID tracking/detection devices. It might not be convenient and/or advisable to have all of the tags attached to an item encode and/or store the same identifier. Hence certain exemplary embodiments can provide an association between a set of identifiers and/or UUID's, each one of them those identifiers unique across their tag technology.

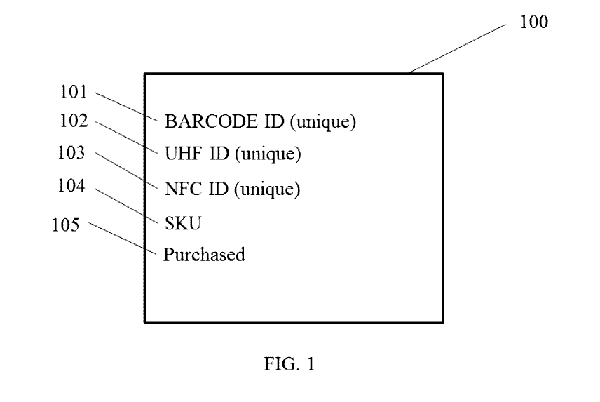

The system can include an Items Database (FIG. 1, 100). In some embodiments this database can be implemented as, for example, an SQL database (e.g., PostgreSQL, MySQL, Oracle SQL, etc.) and/or a noSQL database (e.g., MongoDB, CouchDB, etc.). Each record/row/document in a database can contain a set of UUID's, such as a Barcode ID 101, UHF ID 102, and/or NFC ID 103 (item IDs, all unique), for a specific item that at some point in time can be available for sale. Each record/row/document can contain an SKU (stock keeping unit) 104 of a product, which can establish a one-to-many relationship from any of the item IDs to the SKU of the item. Moreover, every record/row/document can record, store, contain, and/or provide a boolean value that can establish whether the corresponding item has been paid for or not 105.

The Barcode, UHF, and/or NFC IDs can encode and/or store information that can allow distinction of those IDs from IDs that are external to the described system. For instance, the system can distinguish an unutilized EPC barcode from a barcode involved in the system by way of analysing the encoded, stored, and/or associated Barcode ID, potentially ignoring the system-irrelevant EPC barcode. In some embodiments this capability can be realised by setting part of the ID data to a fixed value and/or “address” that associates the remainder of the ID and/or the ID as a whole to the system. In other embodiment, a checksum can be used. This is not necessarily to distinguish between a QR Code ID and UHF ID for instance, but rather to distinguish an accidental external RFID tag being read by a security gate device from an ID associated with the system.

Considering that a UUID can be drawn from a space of all possible ID values, in the aid of scalability of the entire system, an ID space of one or more of the ID type (e.g., Barcode ID, UHF ID, and/or NFC ID, etc.) can be logically partitioned. In some embodiments, the ID spaces can be partitioned by brand, geographical region, and/or temporally, etc. The partitioning can be encoded in the ID data in a way that makes it possible to determine the partition membership by analysing the ID data. For example, the first 24 bits of a given UUID can be a “store code” that identifies in which store the item is stocked. As another example, bits 56 through 96 can identify the brand of the item.

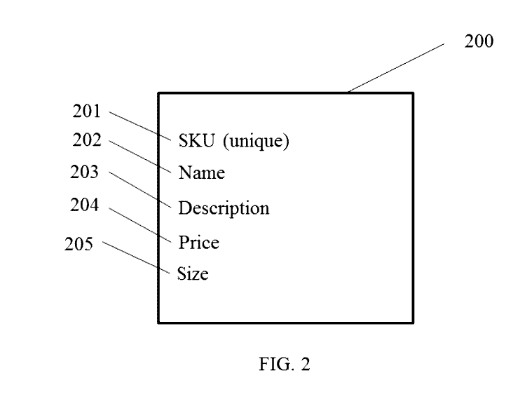

Certain exemplary embodiments can provide a Product Database (FIG. 2, 200). The implementation of the Product Database can be realised in the same or similar way as the Items Database. The Product Database can associate the product SKU 201 (unique) with product data, e.g.: name 202, textual description 203, price 204, and/or size 205, etc.

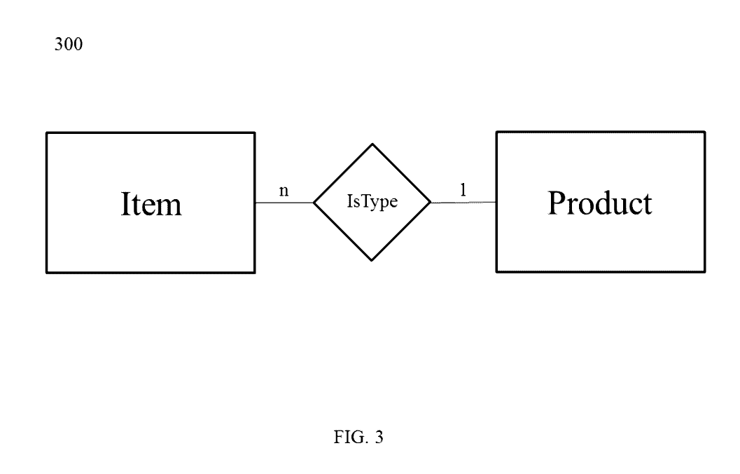

A potential relationship between the items in the Items Database and products in the Product Database is further illustrated in FIG. 3.

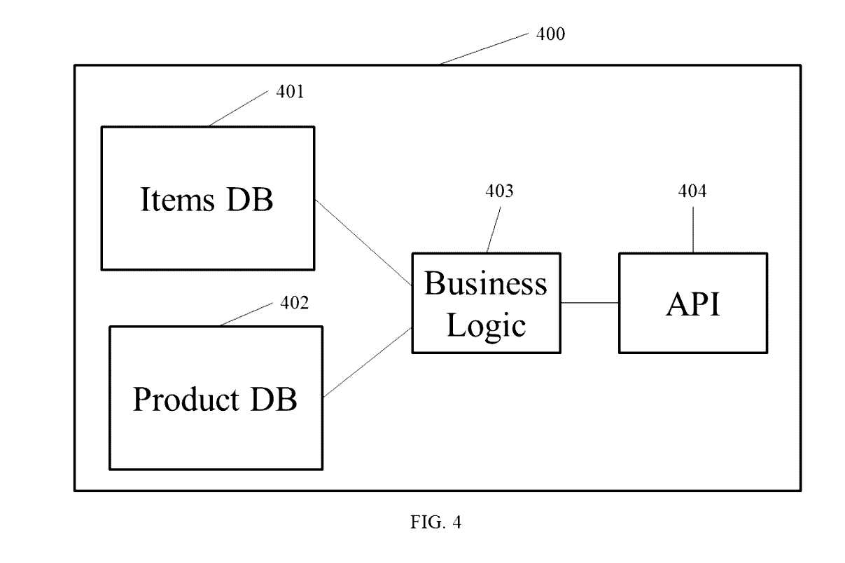

FIG. 4 represents an exemplary design of the backend system. The Items Database 401 and/or the Product Database 402 can be hosted on one or more computers together with business logic computer program 403 written in a computer language (e.g., Ruby, Swift, Python, Erlang, and/or C++, etc) and/or an HTTP-based API 404 that can allow the business logic and/or the databases to be accessible through the internet.

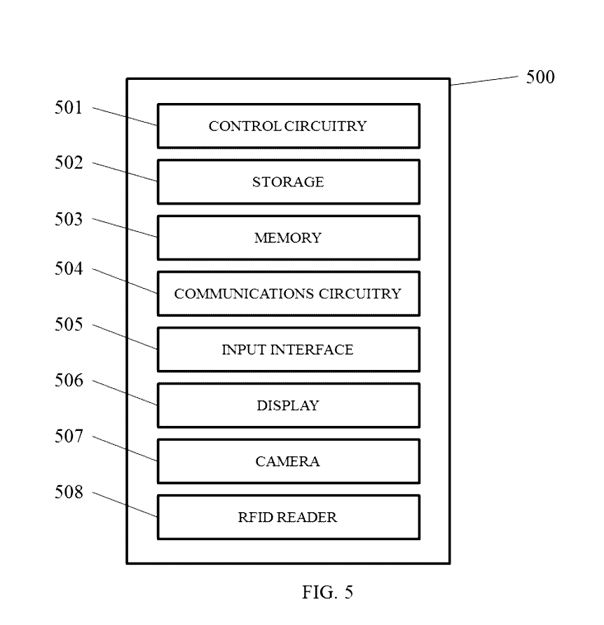

FIG. 5 is a schematic view of an illustrative information device 500, which can include control circuitry 501, storage 502, memory 503, communications circuitry 504, input interface 505, display 506, camera 507, and/or RFID reader chip and antenna 508. In some embodiments, one or more of the components of information device 500 can be combined or omitted. For example, storage 502 and memory 503 can be combined into a single mechanism for storing data. In some embodiments, information device 500 can include other components not combined or included in those shown in FIG. 5, such as a power supply (e.g., a battery or kinetics) and/or a bus. In some embodiments, information device 500 can include several instances of the components shown in FIG. 5 but, for the sake of simplicity, only one of each of the components is shown in FIG. 5. For example, device 500 can include multiple cameras at different locations on the device (e.g., a front camera and a back camera).

Information device 500 can include any suitable type of information device operative to capture an image (e.g., a picture or a frame of a video). For example, information device 500 can include a media player with a camera such as an iPod® available from Apple Inc., of Cupertino, Calif., a cellular telephone with a camera, a personal e-mail or messaging device with a camera (e.g., a Blackberry® or a Sidekick®), an iPhone® available from Apple Inc., a pocket-sized personal computer with a camera, a personal digital assistant (PDA) with a camera, a tablet computer (e.g., an iPad®) and any other suitable information device with an image sensor.

Control circuitry 501 can include any processing circuitry or processor operative to control the operations and performance of an information device of the type of information device 500. Storage 502 and memory 503, which can be combined, can include, for example, one or more storage mediums or memory used in an information device of the type of information device 500.

Communications circuitry 504 can include any suitable communications circuitry operative to connect to a communications network and to transmit communications (e.g., voice or data) from device 500 to other devices within the communications network. Communications circuitry 504 can be operative to interface with the communications network using any suitable communications protocol such as, for example, Wi-Fi (e.g., a 802.11 protocol), Bluetooth®, radio frequency systems (e.g., 900 MHz, 1.4 GHz, and/or 5.6 GHz communication systems), cellular networks (e.g., GSM, AMPS, GPRS, CDMA, EV-DO, EDGE, 3GSM, DECT, IS-136/TDMA, iDen, LTE, and/or any other suitable cellular network or protocol), infrared, TCP/IP (e.g., any of the protocols used in each of the TCP/IP layers), HTTP, BitTorrent, FTP, RTP, RTSP, SSH, Voice over IP (VOIP), and/or any other communications protocol, or any combination thereof. In some embodiments, communications circuitry 504 can be operative to provide wired communications paths for information device 500.

Input interface 505 can include any suitable mechanism or component for receiving inputs from a user. In some embodiments, input interface 505 can include a touch interface for receiving touch inputs from a user. For example, input interface 505 can include a capacitive touch assembly for receiving touch inputs from a user. In some embodiments, input interface 505 can include a touch interface for receiving touch inputs from a user that include multi-touch gestures. Input interface 505 can include circuitry operative to convert (and encode/decode, if necessary) analog signals and other signals into digital data, for example in any manner typical of an information device of the type of information device 500.

Display 506 can include any suitable mechanism for displaying visual content (e.g., images or indicators representing data). For example, display 506 can include a thin-film transistor liquid crystal display (LCD), an organic liquid crystal display (OLCD), a plasma display, a surface-conduction electron-emitter display (SED), organic light-emitting diode display (OLED), and/or any other suitable type of display. In some embodiments, display 506 can include a backlight for illuminating the display. For example, display 506 can include one or more incandescent light bulbs, light-emitting diodes (LEDs), electroluminescent panels (ELPs), cold cathode fluorescent lamps (CCFL), hot cathode fluorescent lamps (HCFL), and/or any other suitable light source, or any combination thereof. Display 506 can display visual content in black-and-white, color, or a combination of the two. Display 506 can display visual content at any suitable brightness level or resolution. In some embodiments, the brightness level and/or resolution of display 506 can be adjusted by a user (e.g., through display configuration options). Display 506 can be electrically coupled with control circuitry 501, storage 502, memory 503, and/or any other suitable components within device 500, or any combination thereof. Display 506 can display images stored in device 500 (e.g., stored in storage 502 and/or memory 503) and/or captured by device 500 (e.g., captured by camera 507).

Camera 507 can include any suitable device for detecting images based on visible light. For example, camera 507 can detect single pictures and/or video frames based on visible light. Camera 507 can include any suitable type of sensor for detecting visible light in an environment. In some embodiments, camera 507 can include a lens and/or one or more sensors that generate electrical signals. The sensors of camera 507 can be provided on a charge-coupled device (CCD) integrated circuit, for example.

In some embodiments, the information device 500 can contain an RFID reader chip 508, which can comprise necessary circuitry to detect and/or read data from an RFID tag (e.g., a chip and an antenna) in the 13.56 MHz RFID band and/or can implement the NFC protocols.

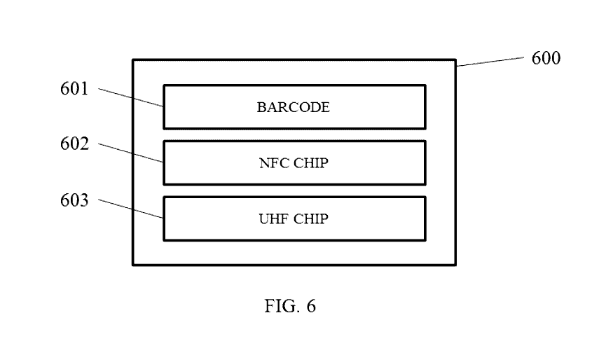

Referring to FIG. 6, a merchandise tag 600 can be attached and/or embedded within a merchandise item. A merchandise tag can encode, store, and/or transmit a UUID using any kind of tag technology, such as a visible barcode 601 (e.g., QR Code, Linear barcode, Aztec Code, and/or Data Matrix, etc.), proximity beacon, NFC RFID tag (chip and antenna) 602, and/or UHF RFID tag (chip and antenna) 603. Each tag can encode and/or store one or more identifiers, such as one or more UUID's, according to data in the Items Database 100.

In some embodiments, the NFC tag 602 need not be present. In other embodiments the NFC tag and the UHF tag can be combined into a hybrid NFC and RFID tag.

In some embodiments, a visible barcode 601, proximity beacon, NFC tag 602, and/or the UHF tag 603 can be physically combined into one physical tag, in others any combination of them can be attached and/or embedded in the item of merchandise separately. For instance, in some embodiments, one or more RFID tags and/or proximity beacons can be woven into the fabric of the item of merchandise.

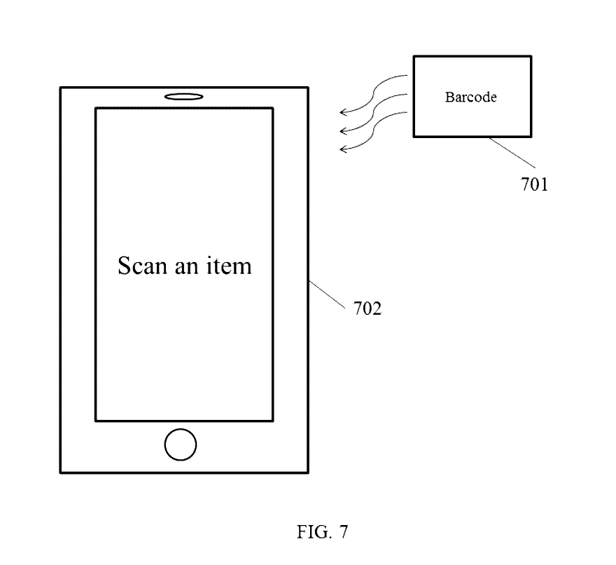

In some embodiments, a Barcode ID can be read, received, and/or retrieved by an information device from a merchandise tag by virtue of capturing the image of the barcode with a camera of the information device and/or analysing that image by appropriate software (e.g., routines of the AVFoundation framework in the Cocoa Touch library of the iOS system and/or the Scandit library available from Scandit Inc. of San Francisco, Calif.) operating on the information device. FIG. 7 is a perspective view of an illustrative system for scanning and retrieving barcode data from a barcode 701 using an information device 702 that is equipped with a camera.

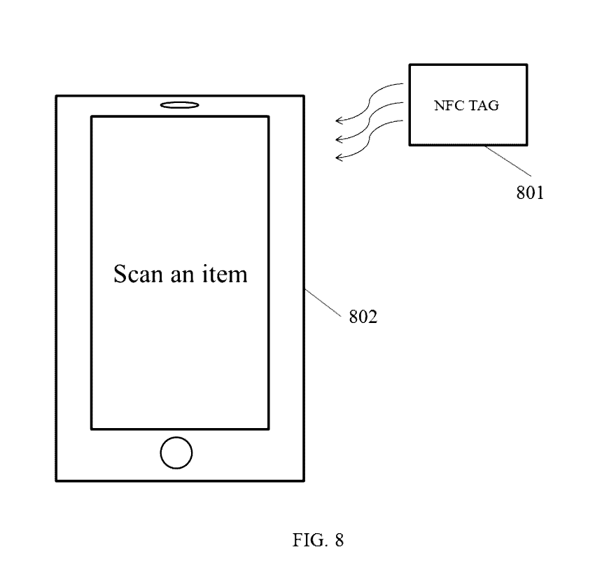

In other embodiments, an NFC ID can be read, received, and/or retrieved by an information device from a merchandise tag. FIG. 8 illustrates an NFC ID being retrieved from an NFC tag 801 by an information device 802 equipped with an RFID reader chip and antenna.

In yet other embodiments, a proximity beacon ID can be read, received, and/or retrieved from a proximity beacon, such as via a Low-Energy Bluetooth connection, by an information device, such as a wireless communication-enabled information device (e.g., a smart phone, tablet, laptop computer, desktop computer, smart watch, and/or wearable computing device, etc.).

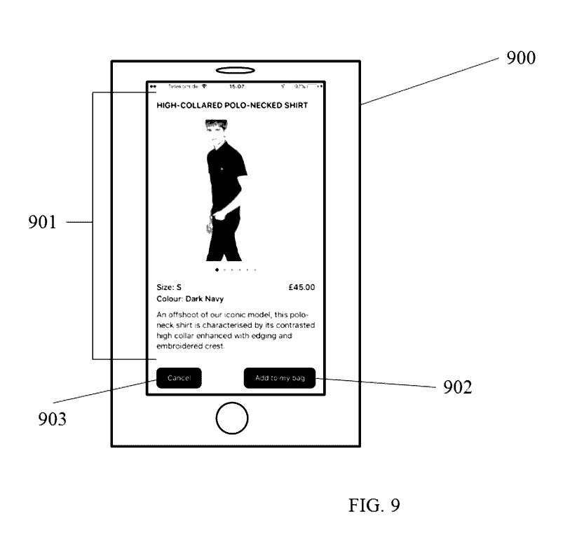

Upon obtaining a UUID, such as a Barcode ID, RFID ID, proximity ID, etc., an information device, such as an information device of a customer, can communicate with the backend to receive and/or display the appropriate product data and/or item data. FIG. 9 illustrates an information device 900 displaying product data such as product name, images, size, color, price, and/or textual description 901, that product data potentially being obtained from the backend, such as via an application or “app” running locally on the information device, via a website, etc. Likewise, information device 900 can be provided by the backend with item data that is specific to that universally unique physical item and/or is specific to a limited number of similar items (but not necessarily all specific items corresponding to the product), such as date/time of manufacture, manufacturing line and/or plant, component suppliers, component receipt dates/times, quality inspector, distributor(s), distribution transfer dates/times, order dates/times, wholesale prices, retailer, store receipt date, shelf address, shelf stocking date, etc. The information device can be empowered and/or caused to display an option to the user (e.g., the customer) to add the scanned item to their electronic shopping basket 902 and/or an option to stop viewing and/or receiving the product data 903 and/or the item data provided by the backend.

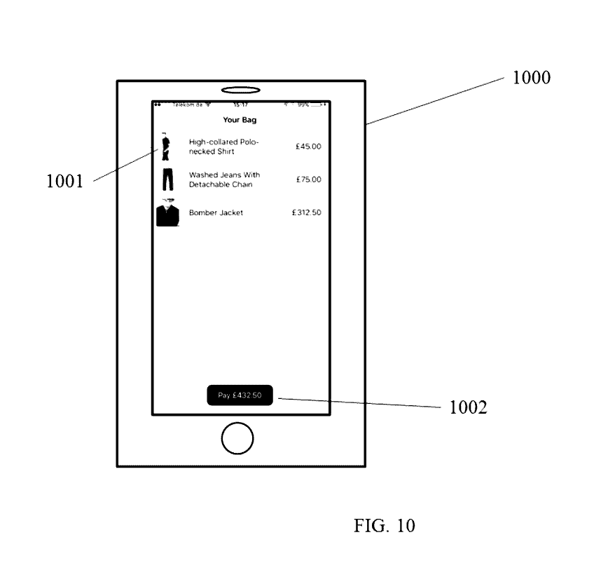

The information device can allow the user, such as a customer, to repeat the tag and/or UUID scanning, transmission, and/or recognition process and/or thereby can allow the user to add more scanned and/or recognized UUID's and/or associated items to their electronic shopping basket. As shown on FIG. 10, an information device 1000 can allow the user to view their electronic shopping basket 1001 and/or, potentially with assistance from the backend, to checkout and/or pay for the items in the electronic shopping basket 1002.

The information device can allow the user to initiate, process, and/or complete an electronic payment in concert with the backend system and/or an electronic payment processing system such as Visa, MasterCard, American Express, and/or Paypal, etc.

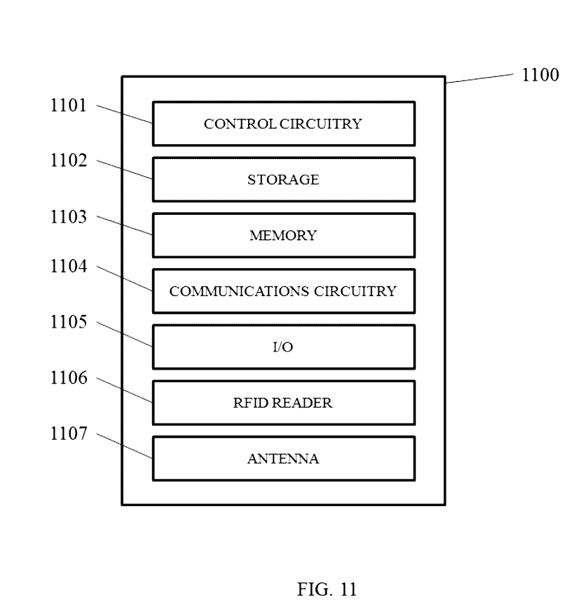

FIG. 11 is a schematic view of an illustrative security gate device and/or tag detection device, which can be used for receiving and/or validating UHF RFID tag identifiers. Security gate device 1100, and/or an information device communicatively coupled thereto, can include control circuitry 1101, storage 1102, memory 1103, communications circuitry 1104, input/output interface 1105, RFID reader 1106, and/or antenna 1107. In some embodiments, one or more of the components of security gate device 1100 can be combined or omitted. For example, storage 1102 and memory 1103 can be combined into a single mechanism for storing data. In some embodiments, security gate device 1100 can include other components not combined or included in those shown in FIG. 11, such as a power supply (e.g., a battery or kinetics) and/or a bus. In some embodiments, security gate device 1100 can include several instances of the components shown in FIG. 11 but, for the sake of simplicity, only one of each of the components is shown in FIG. 11. For example, device 1100 can include multiple antennas at different locations on and/or within the device.

Security gate device 1100 can include any suitable device capable of reading UHF RFID tags. Examples of a security gate device include devices with built in antenna such as xPortal Gateway® or xArray Gateway® available from Impinj Inc. of Seattle, Wash. or without a built in antenna such as Speedway R420® or Speedway R220® available from Impinj Inc. of Seattle, Wash. or Zebra FX9500 available from ZIH Corp. of Lincolnshire, Ill. or similar.

Control circuitry 1101 can include any processing circuitry or processor operative to control the operations and performance of an information device of the type of security gate device 1100. Storage 1102 and memory 1103, which can be combined, can include, for example, one or more storage mediums and/or memory used in an information device of the type of information device 1100.

Communications circuitry 1104 can include any suitable communications circuitry operative to connect to a communications network and/or to transmit communications (e.g., voice and/or data) from device 1100 to other devices within the communications network. Communications circuitry 1104 can be operative to interface with the communications network using any suitable communications protocol such as, for example, Wi-Fi (e.g., a 802.11 protocol), Bluetooth®, radio frequency systems (e.g., 900 MHz, 1.4 GHz, and/or 5.6 GHz communication systems), cellular networks (e.g., GSM, AMPS, GPRS, CDMA, EV-DO, EDGE, 3GSM, DECT, IS-136/TDMA, iDen, LTE, and/or any other suitable cellular network or protocol), infrared, TCP/IP (e.g., any of the protocols used in each of the TCP/IP layers), HTTP, BitTorrent, FTP, RTP, RTSP, SSH, Voice over IP (VOIP), and/or any other communications protocol, or any combination thereof. In some embodiments, communications circuitry 1104 can be operative to provide wired communications paths for security gate device 1100.

Input/output interface 1105 can be a General Purpose Input Output (GPIO) Bus. Through the input/output interface, the security gate device can be connected to an alarm actuator. An alarm actuator can be any device that can be controlled through the input/output interface and/or is configured to provide a visible and/or audible signal and/or an indication of non-purchase of an item. An example of such alarm actuator can be the LU5 or LU7 signal towers available from Patlite Corp. of Torrance, Calif.

UHF RFID Reader 1106 can comprise circuitry to detect and/or read data from an UHF RFID tag (chip and antenna) in the 865-868 MHz (Europe) or 902-928 MHz (North America) band. UHF RFID Reader 1106 can be coupled with a suitable antenna 1106. Antenna 1106 can be built into the security gate device 1100 and/or be can be an external antenna mounted anywhere at the store exit (e.g., the floor, ceiling, walls, frame, and/or standalone, etc.).

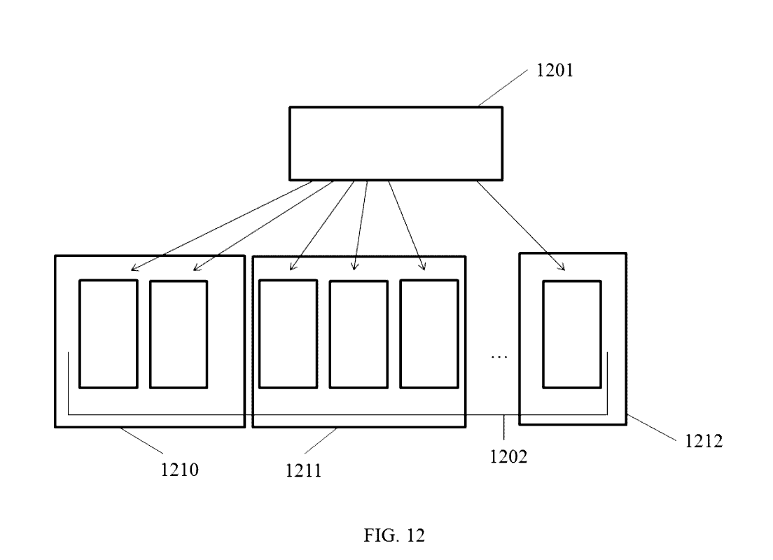

FIG. 12 illustrates an exemplary relationship between the backend 1201 and security gate devices 1202 in a system-wide overview. Each of the security gate devices can communicate with the API 404 of the backend 1201 using their communications circuitry 1104 in a publish-subscribe pattern where the backend can update the security gate devices on the purchase status of the items of merchandise. For instance, when an item has been successfully purchased, backend 1201 can send a message to the relevant security gate devices to update their local databases with this information. In some embodiments, the publish-subscribe pattern can be realised through third-party services like PubNub®, Pusher®, and/or a custom implementation of a publish-subscribe protocol, such as MQTT.

In the interest of scalability the security gate devices can be partitioned in line with the partitioning of the UHF RFID item tag IDs 1210, 1211, 1212. Each security gate device can be configured to take care of one or more partitions and/or can subscribe to receive only updates on tags from those partitions. This can reduce the communications overhead between the backend and the security gate devices and/or reduce the storage needs of the security gate devices.

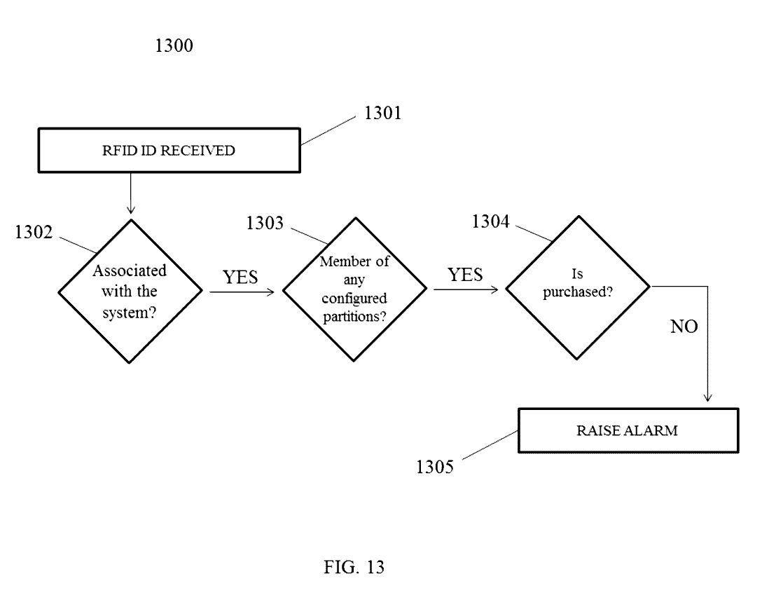

FIG. 13 is a flowchart of an illustrative process 1300 for processing an UHF RFID tag detected by a security gate device. Process 1300 can begin with block 1301 when a UHF tag passes by the security gate device antenna and the UHF ID can be read by the UHF RFID reader of the security gate device and/or passed to its control circuitry. First, the control circuitry can determine whether the UHF ID read is part of the embodied system or if the read tag has a different origin 1302. The control circuitry can do that by analysing the UHF ID data in accordance with a possible encoding described earlier. Tags not recognised as part of the system can be ignored, otherwise the control circuitry can analyse the UHF ID further to establish to which tag partition it belongs and/or whether the security gate device is configured to track and/or detect tags of the said partition 1303. Tags outside of any of the tag partition that the security gate device has been configured to track and/or detect can be ignored and/or the control circuitry can consult a local database in the storage to determine the purchase state of the item associated with the UHF ID 1304. If the item is not known to have been purchased according to the local database, the gate can raise an alarm through the alarm actuator connected to its input/output interface 1305.

Certain exemplary embodiments can allow customers to self-checkout in stores where tags are used, for example in fashion stores, aiming to reduce waiting time at the till in stores.

Certain exemplary embodiments can provide a secure self-checkout because an alarm can be raised when tags associated with unpaid items are recognised by the tags readers at the exits.

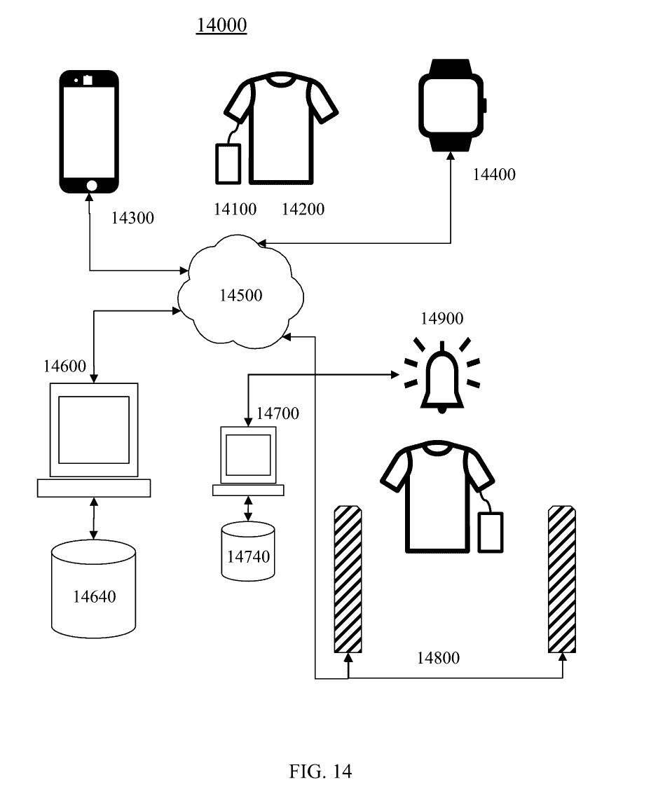

FIG. 14 is a block diagram of an exemplary embodiment of a system 14000, which can comprise a customer information device 14300, 14400, any of which can be connected wirelessly and/or via wired connection to a network 14500, and/or any of which can read a tag 14100 that is physically coupled to and/or intrinsic an item 14200 and/or that stores and/or encodes a UUID that identifies item 14200. Connected to network 14400 can be a backend server 14600, which can administer and/or serve a database 14640 that can provide information about item 14200. Connected to network 14400 can be a tag tracking information device 14700, which can administer and/or serve a database 14740 that can receive information about item 14200. Connected to network 14400 and/or to tag tracking information device 14700 can be a tag detection device 14800, which can read a UUID from a tag physically coupled to and/or intrinsic to item 14200. As controlled by backend server 14600, tag tracking information device 14700, and/or tag detection device 14800, an alarm 14900 can be actuated if item 14200 has not been purchased and/or prevent actuation if item 14200 has been purchased.

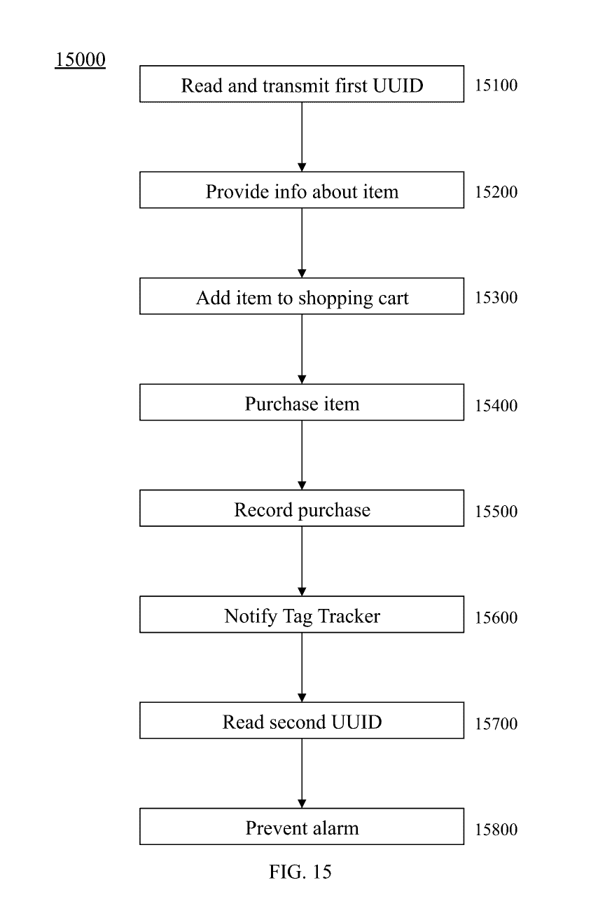

FIG. 15 is a flowchart of an exemplary embodiment of a method 15000. At activity 15100, a first purchasing tag reader, such as attached and/or integral to a customer information device, can read a first UUID from a tag attached and/or integral to a specific item and transmit that first UUID to a backend database server. At activity 15200, the backend database server can search its database and provide information to the customer information device about the specific item and/or a general product associated with the first UUID. At activity 15300, the backend database server and/or the customer information device can add the item to an electronic shopping cart associated with the customer information device and/or an account associated therewith. At activity 15400, the customer information device, potentially assisted by the backend database server, can facilitate a purchase of the item. At activity 15500, an indication of the facilitated, validated, and/or completed purchase can be recorded in the backend database. At activity 15600, the backend database server can notify a tag tracking device, such as a security gate device, that a second UUID associated with the item is associated with a completed purchase. At activity 15700, the tag tracking device can read the second UUID from a second tag attached and/or integral to the item. At activity 15800, the tag tracking device responsive to recognizing that the second UUID is associated with a validated and/or completed purchase, can suppress and/or prevent actuation of an alarm that would otherwise be raised if the second UUID were recognized by the tag reader but not associated with a completed purchase.

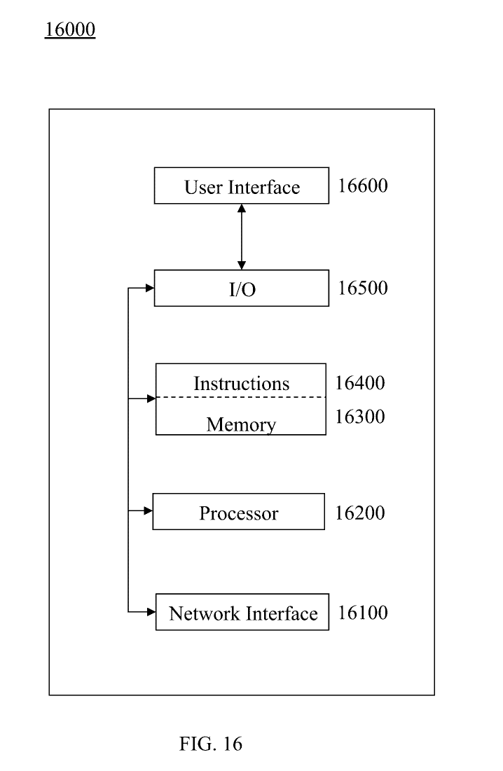

FIG. 16 is a block diagram of an exemplary embodiment of an information device 16000, which in certain operative embodiments can comprise, for example, information device 14300 and/or 14400, backend server 14600, and/or tag tracking information device 14700 of FIG. 14. Information device 16000 can comprise any of numerous transform circuits, which can be formed via any of numerous communicatively-, electrically-, magnetically-, optically-, fluidically-, and/or mechanically-coupled physical components, such as for example, one or more network interfaces 16100, one or more processors 16200, one or more memories 16300 containing instructions 16400, one or more input/output (I/O) devices 16500, and/or one or more user interfaces 16600 coupled to I/O device 16500, etc.

In certain exemplary embodiments, via one or more user interfaces 16600, such as a graphical user interface, a user can view a rendering of information related to researching, designing, modeling, creating, developing, building, manufacturing, operating, maintaining, storing, marketing, selling, delivering, selecting, specifying, requesting, tracking, ordering, selling, purchasing, receiving, returning, rating, and/or recommending any of the products, services, methods, user interfaces, and/or information described herein.

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to:
in a self-checkout system, prior to a purchase of a universally unique item, receiving a first universally unique item identifier of the item from a first tag reader, the first universally unique item identifier read by the first tag reader from a first tag that is attached to the item;
responsive to a determination that the first universally unique item identifier is known to the self-checkout system and associated with a purchase, preventing a tag detection device from raising an alarm upon reading a second tag that is associated with the first universally unique item identifier, the second tag attached to the item and storing a second universally unique item identifier of the item;
responsive to receiving the first universally unique item identifier, searching one or more predetermined databases for the first universally unique item identifier;
responsive to receiving the first universally unique item identifier, obtaining information associated with the first universally unique item identifier from one or more predetermined databases;
responsive to receiving the first universally unique item identifier, providing information about the item to the first tag reader;
responsive to receiving the first universally unique item identifier, providing product information that corresponds to the item to the first tag reader;
receiving an indication that the item is associated with the purchase;
receiving an indication that the first universally unique item identifier is associated with the purchase;
recording in a database an indication that the item is associated with the purchase;
recording in a database an indication that the first universally unique item identifier and/or the second universally unique item identifier is associated with the purchase;
notifying the tag tracking device that the second universally unique item identifier is associated with the purchase of the item;
causing the tag tracking device to actuate the alarm actuator upon:
reading the second universally unique item identifier; and/or
determining that the second universally unique item identifier is known to the self-checkout system and not associated with any purchase;
wherein:
   the first tag reader utilizes a first tag technology;
   the tag detection device utilizes a second tag technology;
   the second tag technology is different from the first tag technology;
   the first tag technology is an RFID technology;
   the first tag technology is a barcode technology;
   the first tag technology is a Bluetooth low energy proximity sensing technology;
   the second tag technology is an RFID technology;
   the first tag and the second tag are combined into a single hybrid tag;
   the first purchasing tag reader is a comprised by an information device; and/or
   the first universally unique item identifier is logically partitioned.

### Definitions

When the following phrases are used substantively herein, the accompanying definitions apply. These phrases and definitions are presented without prejudice, and, consistent with the application, the right to redefine these phrases via amendment during the prosecution of this application or any application claiming priority hereto is reserved. For the purpose of interpreting a claim of any patent that claims priority hereto, each definition in that patent functions as a clear and unambiguous disavowal of the subject matter outside of that definition.
a—at least one.
about—around and/or approximately.
above—at a higher level.
across—from one side to another.
activity—an action, act, step, and/or process or portion thereof.
actuate—to cause a physical and/or humanly perceptible action and/or output.
actuator—a device that converts, translates, and/or interprets signals (e.g., electrical, optical, hydraulic, pneumatic, etc.) to cause a physical and/or humanly perceptible action and/or output, such as a motion (e.g., rotation of a motor shaft, vibration, position of a valve, position of a solenoid, position of a switch, and/or position of a relay, etc.), audible sound (e.g., horn, bell, and/or alarm, etc.), and/or visible rendering (e.g., indicator light, non-numerical display, and/or numerical display, etc).
adapt—to design, make, set up, arrange, shape, configure, and/or make suitable and/or fit for a specific purpose, function, use, and/or situation.
after—following in time and/or subsequent to.
alarm—a warning and/or indication of an existing and/or approaching condition, thing, and/or event.
along—through, on, beside, over, in line with, and/or parallel to the length and/or direction of; and/or from one end to the other of.
and—in conjuction with.
and/or—either in conjunction with or in alternative to.
any—one, some, every, and/or all without specification.
apparatus—an appliance or device for a particular purpose.
approximately—about and/or nearly the same as.
are—to exist.
around—about, surrounding, and/or on substantially all sides of; and/or approximately.
as long as—if and/or since.
associate—to join, connect together, and/or relate.
associated—related to and/or accompanying.
at—in, on, and/or near.
at least—not less than, and possibly more than.
attached—joined and/or secured together.
automatic—performed via an information device in a manner essentially independent of influence and/or control by a user. For example, an automatic light switch can turn on upon “seeing” a person in its “view”, without the person manually operating the light switch.
barcode—information expressible as a series of symbols, such as clusters of dots, parallel bars of varying widths, etc., that can be read by an optical scanner and interpreted as numerical and/or alphabetical characters.
between—in a separating interval and/or intermediate to.
Bluetooth—a short-range radio technology that allows wireless communication between devices such as a computer and a keyboard, between mobile phones, etc.
Boolean logic—a complete system for logical operations.
by—via and/or with the use and/or help of
can—is capable of, in at least some embodiments.
cause—to bring about, provoke, precipitate, produce, elicit, be the reason for, result in, and/or effect.
circuit—a physical system comprising, depending on context: an electrically conductive pathway, an information transmission mechanism, and/or a communications connection, the pathway, mechanism, and/or connection established via a switching device (such as a switch, relay, transistor, and/or logic gate, etc.); and/or an electrically conductive pathway, an information transmission mechanism, and/or a communications connection, the pathway, mechanism, and/or connection established across two or more switching devices comprised by a network and between corresponding end systems connected to, but not comprised by the network.
combine—to join, unite, mix, and/or blend.
composition of matter—a combination, reaction product, compound, mixture, formulation, material, and/or composite formed by a human and/or automation from two or more substances and/or elements.
comprising—including but not limited to.
configure—to design, arrange, set up, shape, and/or make suitable and/or fit for a specific purpose, function, use, and/or situation.
containing—including but not limited to.
convert—to transform, adapt, and/or change.
corresponding—related, associated, accompanying, similar in purpose and/or position, conforming in every respect, and/or equivalent and/or agreeing in amount, quantity, magnitude, quality, and/or degree.
create—to bring into being.
data—distinct pieces of information, usually formatted in a special or predetermined way and/or organized to express concepts, and/or represented in a form suitable for processing by an information device.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
database—a collection of related and/or persistent data specially organized to be stored, distributed, queried, and/or retrieved quickly and/or automatically, often with associated software.
define—to establish the meaning, relationship, outline, form, and/or structure of and/or to precisely and/or distinctly describe and/or specify.
derive—to receive, obtain, and/or produce from a source and/or origin.
detect—to sense, perceive, identify, discover, ascertain, respond to, and/or receive the existence, presence, location, movement, and/or fact of.
determination—a decision and/or an act of making or arriving at a decision.
determine—to find out, obtain, calculate, decide, deduce, ascertain, and/or come to a decision, typically by investigation, reasoning, and/or calculation.
device—a machine, manufacture, and/or collection thereof.
different—changed, distinct, and/or separate.
digital—non-analog and/or discrete.
each—every one of a group considered individually.
effective—sufficient to bring about, provoke, elicit, and/or cause.
embodiment—an implementation, manifestation, and/or concrete representation.
energy—a measurable physical quantity, with dimensions equivalent and/or convertible to mass times velocity squared, that is conserved for an isolated system.
estimate—(n) a calculated value approximating an actual value; (v) to calculate and/or determine approximately and/or tentatively.
exemplary—serving as an example, instance, and/or illustration.
first—an initial element in a set.
for—with a purpose of
from—used to indicate a source, origin, and/or location thereof.
further—in addition.
generate—to create, produce, give rise to, and/or bring into existence.
given—
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
having—including but not limited to.
human-machine interface—hardware and/or software adapted to render information to a user and/or receive information from the user; and/or a user interface.
hybrid—something of mixed origin and/or composition.
identifier—a group of symbols that are unique to a particular entity, object, activity, service, relationship, characteristic, and/or document. An identifier can be human and/or machine readable and/or understandable, such as for example, a number, alphanumeric string, code, bar code, RFID, etc.
implement—to accomplish some aim and/or execute some order.
including—including but not limited to.
indication—a sign, token, and/or suggestion.
information device—any device capable of processing data and/or information, such as any general purpose and/or special purpose computer, such as a personal computer, workstation, server, minicomputer, mainframe, supercomputer, computer terminal, laptop, tablet computer (such as an iPad-like device), wearable computer, Personal Digital Assistant (PDA), mobile terminal, Bluetooth device, communicator, “smart” phone (such as an iPhone-like device), messaging service (e.g., Blackberry) receiver, pager, facsimile, cellular telephone, traditional telephone, telephonic device, embedded controller, programmed microprocessor or microcontroller and/or peripheral integrated circuit elements, ASIC or other integrated circuit, hardware electronic logic circuit such as a discrete element circuit, and/or programmable logic device such as a PLD, PLA, FPGA, or PAL, or the like, etc. In general, any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc. In information device can be a component of and/or augment another device, such as an appliance, machine, tool, robot, vehicle, television, printer, “smart” utility meter, etc.
initialize—to prepare something for use and/or some future event.
input/output (I/O) device—any device adapted to provide input to, and/or receive output from, an information device. Examples can include an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, switch, relay, haptic device, vibrator, tactile simulator, and/or tactile pad, potentially including a port to which an I/O device can be attached or connected.
install—to connect or set in position and prepare for use.
instructions—directions, which can be implemented as hardware, firmware, and/or software, the directions adapted to perform a particular operation and/or function via creation and/or maintenance of a predetermined physical circuit.
into—to a condition, state, or form of
is—to exist in actuality.
item—a single article of a plurality of articles.
known—recognized or understood.
logic gate—a physical device adapted to perform a logical operation on one or more logic inputs and to produce a single logic output, which is manifested physically. Because the output is also a logic-level value, an output of one logic gate can connect to the input of one or more other logic gates, and via such combinations, complex operations can be performed. The logic normally performed is Boolean logic and is most commonly found in digital circuits. The most common implementations of logic gates are based on electronics using resistors, transistors, and/or diodes, and such implementations often appear in large arrays in the form of integrated circuits (a.k.a., IC's, microcircuits, microchips, silicon chips, and/or chips). It is possible, however, to create logic gates that operate based on vacuum tubes, electromagnetics (e.g., relays), mechanics (e.g., gears), fluidics, optics, chemical reactions, and/or DNA, including on a molecular scale. Each electronically-implemented logic gate typically has two inputs and one output, each having a logic level or state typically physically represented by a voltage. At any given moment, every terminal is in one of the two binary logic states (“false” (a.k.a., “low” or “0”) or “true” (a.k.a., “high” or “1”), represented by different voltage levels, yet the logic state of a terminal can, and generally does, change often, as the circuit processes data. Thus, each electronic logic gate typically requires power so that it can source and/or sink currents to achieve the correct output voltage. Typically, machine-implementable instructions are ultimately encoded into binary values of “0”s and/or “1”s and, are typically written into and/or onto a memory device, such as a “register”, which records the binary value as a change in a physical property of the memory device, such as a change in voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc. An exemplary register might store a value of “01101100”, which encodes a total of 8 “bits” (one byte), where each value of either “0” or “1” is called a “bit” (and 8 bits are collectively called a “byte”). Note that because a binary bit can only have one of two different values (either “0” or “1”), any physical medium capable of switching between two saturated states can be used to represent a bit. Therefore, any physical system capable of representing binary bits is able to represent numerical quantities, and potentially can manipulate those numbers via particular encoded machine-implementable instructions. This is one of the basic concepts underlying digital computing. At the register and/or gate level, a computer does not treat these “0”s and “1”s as numbers per se, but typically as voltage levels (in the case of an electronically-implemented computer), for example, a high voltage of approximately +3 volts might represent a “1” or “logical true” and a low voltage of approximately 0 volts might represent a “0” or “logical false” (or vice versa, depending on how the circuitry is designed). These high and low voltages (or other physical properties, depending on the nature of the implementation) are typically fed into a series of logic gates, which in turn, through the correct logic design, produce the physical and logical results specified by the particular encoded machine-implementable instructions. For example, if the encoding request a calculation, the logic gates might add the first two bits of the encoding together, produce a result “1” (“0”+“1”=“1”), and then write this result into another register for subsequent retrieval and reading. Or, if the encoding is a request for some kind of service, the logic gates might in turn access or write into some other registers which would in turn trigger other logic gates to initiate the requested service.
logical—a conceptual representation.
machine-implementable instructions—directions adapted to cause a machine, such as an information device, to perform one or more particular activities, operations, and/or functions via forming a particular physical circuit. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied and/or encoded as machine code, source code, object code, compiled code, assembled code, interpretable code, and/or executable code, etc., in hardware, firmware, and/or software.
machine-readable medium—a transitory and/or non-transitory physical and/or tangible structure via which a machine, such as an information device, computer, microprocessor, and/or controller, etc., can store or carry one or more machine-implementable instructions, data structures, data, and/or information and/or obtain one or more stored machine-implementable instructions, data structures, data, and/or information. Examples include a memory device, punch card, player-plano scroll, etc.
may—is allowed and/or permitted to, in at least some embodiments.
memory device—an apparatus capable of storing, sometimes permanently, machine-implementable instructions, data, and/or information, in analog and/or digital format. Examples include at least one non-volatile memory, volatile memory, register, relay, switch, Random Access Memory, RAM, Read Only Memory, Erasable Programmable Read-Only Memory (EPROM), Electrically Erasable Programmable Read-Only Memory (EEPROM), ROM, flash memory, magnetic media, hard disk, floppy disk, magnetic tape, optical media, optical disk, compact disk, CD, digital versatile disk, DVD, and/or raid array, etc. The memory device can be coupled to a processor and/or can store and provide instructions adapted to be executed by processor, such as according to an embodiment disclosed herein.
method—one or more acts that are performed upon subject matter to be transformed to a different state or thing and/or are tied to a particular apparatus, said one or more acts not a fundamental principal and not pre-empting all uses of a fundamental principal.
near—a distance of less than approximately [X].
network—a communicatively coupled plurality of nodes, communication devices, and/or information devices. Via a network, such nodes and/or devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, radio, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, Bluetooth, Airport, IEEE 802.11, IEEE 802.11a, IEEE 802.11b, IEEE 802.11g, X-10, electrical power, 3G, 4G, multi-domain, and/or multi-zone sub-network and/or protocol, one or more Internet service providers, one or more network interfaces, and/or one or more information devices, such as a switch, router, and/or gateway not directly connected to a local area network, etc., and/or any equivalents thereof.
network interface—any physical and/or logical device, system, and/or process capable of coupling an information device to a network. Exemplary network interfaces comprise a telephone, cellular phone, cellular modem, telephone data modem, fax modem, wireless transceiver, communications port, ethernet card, cable modem, digital subscriber line interface, bridge, hub, router, or other similar device, software to manage such a device, and/or software to provide a function of such a device.
no—an absence of and/or lacking any.
not—a negation of something.
notify—to inform, advise, and/or remind.
one—being and/or amounting to a single unit, individual, and/or entire thing, item, and/or object.
operable—practicable and/or fit, ready, and/or configured to be put into its intended use and/or service.
or—a conjunction used to indicate alternatives, typically appearing only before the last item in a group of alternative items.
outside—beyond a range, boundary, and/or limit; and/or not within.
packet—a generic term for a bundle of data organized in a specific way for transmission, such as within and/or across a network, such as a digital packet-switching network, and comprising the data to be transmitted and certain control information, such as a destination address.
per—for each and/or by means of.
perceptible—capable of being perceived by the human senses.
physical—tangible, real, and/or actual.
physically—existing, happening, occurring, acting, and/or operating in a manner that is tangible, real, and/or actual.
plurality—the state of being plural and/or more than one.
portion—a part, component, section, percentage, ratio, and/or quantity that is less than a larger whole.
pre-—a prefix that precedes an activity that has occurred beforehand and/or in advance.
predetermine—to determine, decide, and/or establish in advance.
prevent—to impede, hinder, avert, stop, and/or keep from happening.
prior—before and/or preceding in time or order.
probability—a quantitative representation of a likelihood of an occurrence.
processor—a machine that utilizes hardware, firmware, and/or software and is physically adaptable to perform, via Boolean logic operating on a plurality of logic gates that form particular physical circuits, a specific task defined by a set of machine-implementable instructions. A processor can utilize mechanical, pneumatic, hydraulic, electrical, magnetic, optical, informational, chemical, and/or biological principles, mechanisms, adaptations, signals, inputs, and/or outputs to perform the task(s). In certain embodiments, a processor can act upon information by manipulating, analyzing, modifying, and/or converting it, transmitting the information for use by machine-implementable instructions and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium family of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
product—something produced by human and/or mechanical effort.
project—to calculate, estimate, or predict.
provide—to furnish, supply, give, and/or make available.
proximity—the state, quality, sense, and/or fact of being near and/or next; the closeness of one thing to another.
purchase—to obtain one or more rights (typically possession rights and frequently all rights) in a property in exchange for money or an equivalent of money.
raise—to cause to arise, appear, sound, and/or exist.
range—a measure of an extent of a set of values and/or an amount and/or extent of variation.
ratio—a relationship between two quantities expressed as a quotient of one divided by the other.
read—to obtain the content of.
reader—a device adapted to receive an identifier from a tag.
receive—to get as a signal, take, acquire, and/or obtain.
recommend—to suggest, praise, commend, and/or endorse.
reduce—to make and/or become lesser and/or smaller.
remove—to eliminate, remove, and/or delete, and/or to move from a place or position occupied.
render—to, e.g., physically, chemically, biologically, electronically, electrically, magnetically, optically, acoustically, fluidically, and/or mechanically, etc., transform information into a form perceptible to a human as, for example, data, commands, text, graphics, audio, video, animation, and/or hyperlinks, etc., such as via a visual, audio, and/or haptic, etc., means and/or depiction, such as via a display, monitor, electric paper, ocular implant, cochlear implant, speaker, vibrator, shaker, force-feedback device, stylus, joystick, steering wheel, glove, blower, heater, cooler, pin array, tactile touchscreen, etc.
repeat—to do again and/or perform again.
repeatedly—again and again; repetitively.
request—to express a desire for and/or ask for.
responsive—reacting to an activity, influence, and/or impetus.
result—(n.) an outcome and/or consequence of a particular action, operation, and/or course; (v.) to cause an outcome and/or consequence of a particular action, operation, and/or course.
RFID—Radio Frequency Identification.
said—when used in a system or device claim, an article indicating a subsequent claim term that has been previously introduced.
second—following a first thing in an ordering and/or set.
select—to make a choice or selection from alternatives.
self-checkout—a mechanism for customers to pay for purchases from a retailer without direct input to the process by the retailer's staff
sense—to detect and/or perceive automatically.
server—an information device and/or a process running thereon, that is adapted to be communicatively coupled to a network and that is adapted to provide at least one service for at least one client, i.e., for at least one other information device communicatively coupled to the network and/or for at least one process running on another information device communicatively coupled to the network. One example is a file server, which has a local drive and services requests from remote clients to read, write, and/or manage files on that drive. Another example is an e-mail server, which provides at least one program that accepts, temporarily stores, relays, and/or delivers e-mail messages. Still another example is a database server, which processes database queries. Yet another example is a device server, which provides networked and/or programmable: access to, and/or monitoring, management, and/or control of, shared physical resources and/or devices, such as information devices, printers, modems, scanners, projectors, displays, lights, cameras, security equipment, proximity readers, card readers, kiosks, POS/retail equipment, phone systems, residential equipment, HVAC equipment, medical equipment, laboratory equipment, industrial equipment, machine tools, pumps, fans, motor drives, scales, programmable logic controllers, sensors, data collectors, actuators, alarms, annunciators, and/or input/output devices, etc.
set—a related plurality.
signal—(v) to communicate; (n) one or more automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc., that can encode information, such as machine-implementable instructions for activities and/or one or more letters, words, characters, symbols, signal flags, visual displays, and/or special sounds, etc., having prearranged meaning. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
single—existing alone and/or consisting of one entity.
special purpose computer—a computer and/or information device comprising a processor device having a plurality of logic gates, whereby at least a portion of those logic gates, via implementation of specific machine-implementable instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine-implementable instructions to the logic gate's specific configuration and property(ies). In the context of an electronic computer, each such change in the logic gates creates a specific electrical circuit, thereby directly tying the specific machine-implementable instructions to that specific electrical circuit.
special purpose processor—a processor device, having a plurality of logic gates, whereby at least a portion of those logic gates, via implementation of specific machine-implementable instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine-implementable instructions to the logic gate's specific configuration and property(ies). In the context of an electronic computer, each such change in the logic gates creates a specific electrical circuit, thereby directly tying the specific machine-implementable instructions to that specific electrical circuit.
species—a class of individuals and/or objects grouped by virtue of their common attributes and assigned a common name; a division subordinate to a genus.
store—to place, hold, and/or retain data, typically in a memory.
substantially—to a great extent and/or degree.
switch—(v) to: form, open, and/or close one or more circuits; form, complete, and/or break an electrical and/or informational path; select a path and/or circuit from a plurality of available paths and/or circuits; and/or establish a connection between disparate transmission path segments in a network (or between networks); (n) a physical device, such as a mechanical, electrical, and/or electronic device, that is adapted to switch.
system—a collection of mechanisms, devices, machines, articles of manufacture, processes, data, and/or instructions, the collection designed to perform one or more specific functions.
tag—(n) a group of text, numbers, characters, and/or symbols identifies an item to which the tag is printed, molded, attached, embedded, physically coupled, and/or associated; (v) to label, describe, identify, and/or classify.
technology—the application of science, especially to industrial and/or commercial objectives, and/or the methods, theory, and/or practices governing such application.
that—used as the subject or object of a relative clause.
through—across, among, between, and/or in one side and out the opposite and/or another side of
to—a preposition adapted for use for expressing purpose.
transform—to change in measurable: form, appearance, nature, and/or character.
transmit—to send as a signal, provide, furnish, and/or supply.
treatment—an act, manner, or method of handling and/or dealing with someone and/or something.
unique—existing as the only one, having no equal, and/or distinctive in some attribute.
universally—everywhere, in every case, and/or without exception.
upon—immediately or very soon after; and/or on the occasion of.
use—to put into service.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
utilize—to use and/or put into service.
validate—to corroborate and/or establish the validity and/or soundness of.
via—by way of and/or utilizing.
weight—a force with which a body is attracted to Earth or another celestial body, equal to the product of the object's mass and the acceleration of gravity; and/or a factor and/or value assigned to a number in a computation, such as in determining an average, to make the number's effect on the computation reflect its importance, significance, preference, impact, etc.
when—at a time and/or during the time at which.
wherein—in regard to which; and; and/or in addition to.
with—accompanied by.
with regard to—about, regarding, relative to, and/or in relation to.
with respect to—about, regarding, relative to, and/or in relation to.
within—inside the limits of.
zone—a region and/or volume having at least one predetermined boundary.

### Note

Various substantially and specifically practical and useful exemplary embodiments of the claimed subject matter are described herein, textually and/or graphically, including the best mode, if any, known to the inventor(s), for implementing the claimed subject matter by persons having ordinary skill in the art. Any of numerous possible variations (e.g., modifications, augmentations, embellishments, refinements, and/or enhancements, etc.), details (e.g., species, aspects, nuances, and/or elaborations, etc.), and/or equivalents (e.g., substitutions, replacements, combinations, and/or alternatives, etc.) of one or more embodiments described herein might become apparent upon reading this document to a person having ordinary skill in the art, relying upon his/her expertise and/or knowledge of the entirety of the art and without exercising undue experimentation. The inventor(s) expects any person having ordinary skill in the art, after obtaining authorization from the inventor(s), to implement such variations, details, and/or equivalents as appropriate, and the inventor(s) therefore intends for the claimed subject matter to be practiced other than as specifically described herein. Accordingly, as permitted by law, the claimed subject matter includes and covers all variations, details, and equivalents of that claimed subject matter. Moreover, as permitted by law, every combination of the herein described characteristics, functions, activities, substances, and/or structural elements, and all possible variations, details, and equivalents thereof, is encompassed by the claimed subject matter unless otherwise clearly indicated herein, clearly and specifically disclaimed, or otherwise clearly inoperable or contradicted by context.

The use of any and all examples, or exemplary language (e.g., “such as”) provided herein, is intended merely to better illuminate one or more embodiments and does not pose a limitation on the scope of any claimed subject matter unless otherwise stated. No language herein should be construed as indicating any non-claimed subject matter as essential to the practice of the claimed subject matter.

Thus, regardless of the content of any portion (e.g., title, field, background, summary, description, abstract, drawing figure, etc.) of this document, unless clearly specified to the contrary, such as via explicit definition, assertion, or argument, or clearly contradicted by context, with respect to any claim, whether of this document and/or any claim of any document claiming priority hereto, and whether originally presented or otherwise:
there is no requirement for the inclusion of any particular described characteristic, function, activity, substance, or structural element, for any particular sequence of activities, for any particular combination of substances, or for any particular interrelationship of elements;
no described characteristic, function, activity, substance, or structural element is “essential”; and
within, among, and between any described embodiments:
   any two or more described substances can be mixed, combined, reacted, separated, and/or segregated;
   any described characteristics, functions, activities, substances, and/or structural elements can be combined, integrated, segregated, and/or duplicated;
   any described activity can be performed manually, semi-automatically, and/or automatically;
   any described activity can be repeated, any activity can be combined with any other described activity, performed by multiple entities, and/or performed in multiple jurisdictions; and
   any described characteristic, function, activity, substance, and/or structural element can be specifically excluded, the sequence of activities can vary, and/or the interrelationship of structural elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted.

When any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate sub-range defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all sub-ranges therebetween, such as for example, 1 to 3.65, 2.8 to 8.14, 1.93 to 9, etc., even if those specific values or specific sub-ranges are not explicitly stated.

When any phrase (i.e., one or more words) appearing in a claim is followed by a drawing element number, that drawing element number is exemplary and non-limiting on claim scope.

No claim of this document is intended to invoke 35 USC 112(f) unless the precise phrase “means for” is followed by a gerund.

Any information in any material (e.g., a United States patent, United States patent application, book, article, web page, etc.) that has been incorporated by reference herein, is incorporated by reference herein in its entirety to its fullest enabling extent permitted by law yet only to the extent that no conflict exists between such information and the other definitions, statements, and/or drawings set forth herein. In the event of such conflict, including a conflict that would render invalid any claim herein or seeking priority hereto, then any such conflicting information in such material is specifically not incorporated by reference herein. Any specific information in any portion of any material that has been incorporated by reference herein that identifies, criticizes, or compares to any prior art is not incorporated by reference herein.

Applicant intends that each claim presented herein and at any point during the prosecution of this application, and in any application that claims priority hereto, defines a distinct patentable invention and that the scope of that invention must change commensurately if and as the scope of that claim changes during its prosecution. Thus, within this document, and during prosecution of any patent application related hereto, any reference to any claimed subject matter is intended to reference the precise language of the then-pending claimed subject matter at that particular point in time only.

Accordingly, every portion (e.g., title, field, background, summary, description, abstract, drawing figure, etc.) of this document, other than the claims themselves and any provided definitions of the phrases used therein, is to be regarded as illustrative in nature, and not as restrictive. The scope of subject matter protected by any claim of any patent that issues based on this document is defined and limited only by the precise language of that claim (and all legal equivalents thereof) and any provided definition of any phrase used in that claim, as informed by the context of this document.

What is claimed is:

1. A method comprising:
in a self-checkout system, prior to a purchase of a universally unique item, receiving a first universally unique item identifier of the item from a first tag reader, the first universally unique item identifier read by the first tag reader from a first tag that is attached to the item;
responsive to a determination that the first universally unique item identifier is known to the self-checkout system and associated with a purchase, preventing a tag detection device from raising an alarm upon reading a second tag that is associated with the first universally unique item identifier, the second tag attached to the item and storing a second universally unique item identifier of the item;
wherein:
the first tag reader utilizes a first tag technology;
the tag detection device utilizes a second tag technology;
the second tag technology is different from the first tag technology.

2. The method of claim 1, further comprising:
responsive to receiving the first universally unique item identifier, searching one or more predetermined databases for the first universally unique item identifier.

3. The method of claim 1, further comprising:
responsive to receiving the first universally unique item identifier, obtaining information associated with the first universally unique item identifier from one or more predetermined databases.

4. The method of claim 1, further comprising:
responsive to receiving the first universally unique item identifier, providing information about the item to the first tag reader.

5. The method of claim 1, further comprising:
responsive to receiving the first universally unique item identifier, providing product information that corresponds to the item to the first tag reader.

6. The method of claim 1, further comprising:
receiving an indication that the item is associated with the purchase.

7. The method of claim 1, further comprising:
receiving an indication that the first universally unique item identifier is associated with the purchase.

8. The method of claim 1, further comprising:
recording in a database an indication that the item is associated with the purchase.

9. The method of claim 1, further comprising:
recording in a database an indication that the first universally unique item identifier and/or the second universally unique item identifier is associated with the purchase.

10. The method of claim 1, further comprising:
notifying the tag tracking device that the second universally unique item identifier is associated with the purchase of the item.

11. The method of claim 1, further comprising:
causing the tag tracking device to actuate the alarm actuator upon:
reading the second universally unique item identifier; and
determining that the second universally unique item identifier is known to the self-checkout system and not associated with any purchase.

12. The method of claim 1, wherein:
the first tag technology is an RFID technology.

13. The method of claim 1, wherein:
the first tag technology is a barcode technology.

14. The method of claim 1, wherein:
the first tag technology is a Bluetooth low energy proximity sensing technology.

15. The method of claim 1, wherein:
the second tag technology is an RFID technology.

16. The method of claim 1, wherein:
the first tag and the second tag are combined into a single hybrid tag.

17. The method of claim 1, wherein:
the first purchasing tag reader is a comprised by an information device.

18. The method of claim 1, wherein:
the first universally unique item identifier is logically partitioned.

19. A machine-readable medium storing machine-implementable instructions for activities comprising:
in a self-checkout system, prior to a purchase of a universally unique item, receiving a first universally unique item identifier of the item from a first tag reader, the first universally unique item identifier read by the first tag reader from a first tag that is attached to the item;
responsive to a determination that the first universally unique item identifier is known to the self-checkout system and associated with a purchase, preventing a tag tracking device from raising an alarm upon reading a second tag that is associated with the first universally unique item identifier, the second tag attached to the item and encoding a second universally unique item identifier of the item;
wherein:
the first tag reader utilizes a first tag technology;
the tag tracking device utilizes a second tag technology;
the second tag technology is different from the first tag technology.

20. A circuit comprising:
a first sub-circuit adapted to in a self-checkout system, prior to a purchase of a universally unique item, receive a first universally unique item identifier of the item from a first tag reader, the first universally unique item identifier read by the first tag reader from a first tag that is attached to the item;
a second sub-circuit configured to, responsive to a determination that the first universally unique item identifier is known to the self-checkout system and associated with a purchase, prevent a tag tracking device from raising an alarm upon reading a second tag that is associated with the first universally unique item identifier, the second tag attached to the item and encoding a second universally unique item identifier of the item;
wherein:
the first tag reader utilizes a first tag technology;
the tag tracking device utilizes a second tag technology;
the second tag technology is different from the first tag technology.
